(19) United States
(12) Patent Application Publication
(10) Pub. No.: US 2009/0320822 A1
(43) Pub. Date: Dec. 31, 2009

(54) Portable barbeque

(76) Inventor: Jui-Ju Yeh, Taipei (TW)

Correspondence Address: POSZ LAW GROUP, PLC, 12040 SOUTH LAKES DRIVE, SUITE 101, RESTON, VA, 20191, US

(21) Appl. No.: 12/213,895

(22) Filed: Jun. 26, 2008

(51) Int. Cl. A47J 37/07

(52) U.S. Cl. 126/25 R

(57) ABSTRACT

A portable barbeque has a grill and a stand. The grill has a bottom. The stand is mounted in the bottom of the grill and has a primary leg assembly and a secondary leg. The primary leg assembly has two primary legs, each having a pivot pole and a main pole pivotally connected and mounted on the grill. The secondary leg is pivotally connected to the main poles, has a crossbar detachably mounted on the bottom of the grill, two leg poles being attached to and protruding from the crossbar and multiple wheels rotatably mounted on the leg poles. When folded, an inward-movement of the pivot poles adjusts a protruding length of the main poles relative to the secondary pole; thereby, affording a smaller footprint for convenient storage and transport.

### BACKGROUND OF THE INVENTION

1. Field of the Invention

The present invention relates to a barbeque grill, and more particularly to a portable barbeque that ensures ends of legs of a stand therefor protrude evenly for a smaller footprint when folded for convenient storage and transportation.

2. Description of Related Art

A portable barbeque grill comprises a foldable stand and a grill pan. The foldable stand comprises two legs pivotally attached to two sides of the grill pan, the grill pan further having a stop on one side. The legs are pivotally mounted to each other and one is pivotally mounted to the side of the grill, the legs abut the ground and support the grill when unfolded. When folding the stand, the legs are pivoted toward each other and align with each other, allowing the grill to pivot to be parallel with the legs for convenient and compact storage.

However, the legs must be substantially the same length to hold the grill horizontal for cooking, therefore, when folded, ends of the legs are not aligned, so the end of one leg protrudes relative to the end of the other leg. This increases space required to store the barbeque when folded and makes the barbeque awkward to store. Otherwise, the barbeque is normally carried, which is inconvenient.

The present invention therefore provides a portable barbeque to obviate or mitigate the aforementioned problems.

### SUMMARY OF THE INVENTION

The main objective of the present invention is to provide a portable barbeque that ensures ends of legs of a stand therefor protrude evenly for a smaller footprint when folded for convenient storage and transportation.

To achieve the objective, a portable barbeque has a grill and a stand. The grill has a bottom. The stand is mounted in the bottom of the grill and comprises a primary leg assembly and a secondary leg. The primary leg assembly comprises two primary legs, each having a pivot pole and a main pole pivotally connected and mounted on the grill. The secondary leg is pivotally connected to the main poles, has a crossbar detachably mounted on the bottom of the grill, two leg poles being attached to and protruding from the crossbar and multiple wheels rotatably mounted on the leg poles. When folded, an inward-movement of the pivot poles adjusts a protruding length of the main poles relative to the secondary pole; thereby, affording a smaller footprint for convenient storage and transport.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a portable barbeque in accordance with the present invention;

FIG. 2 is another perspective view of the portable barbeque in FIG. 1;

FIG. 3 is an operational side view of the portable barbeque in FIG. 1;

FIG. 4 is an operational perspective view of the portable barbeque in FIG. 1, shown folded;

FIG. 5 is an operational front view of the portable barbeque in FIG. 1, shown folded; and

FIG. 6 is an operational side view of the portable barbeque in FIG. 1, shown folded.

### DETAILED DESCRIPTION OF THE PREFERRED EMBODIMENT

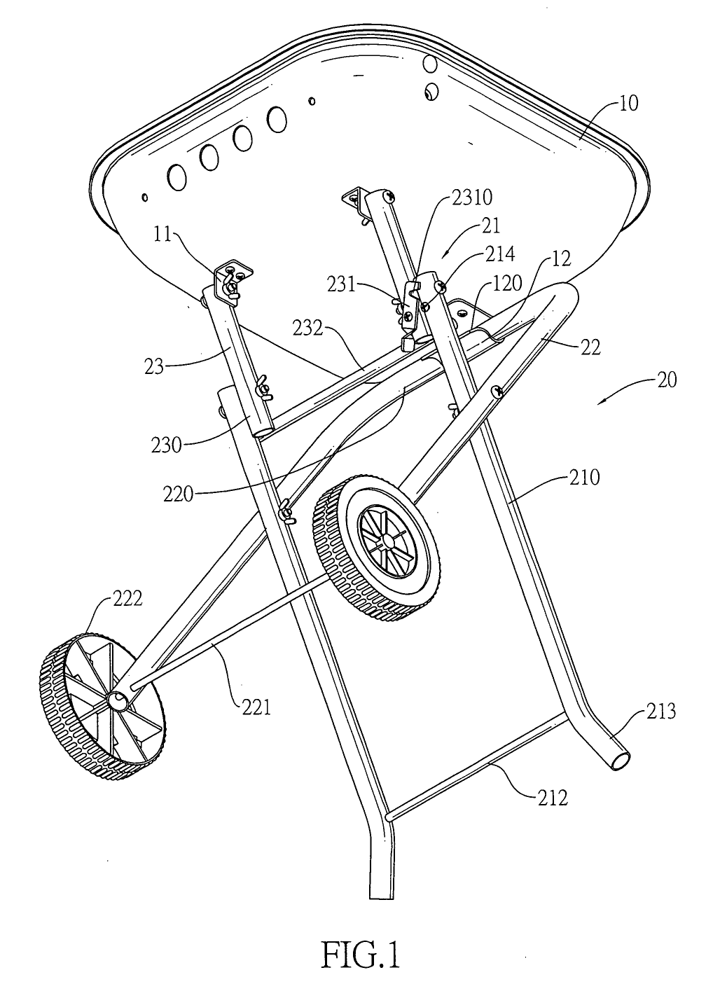

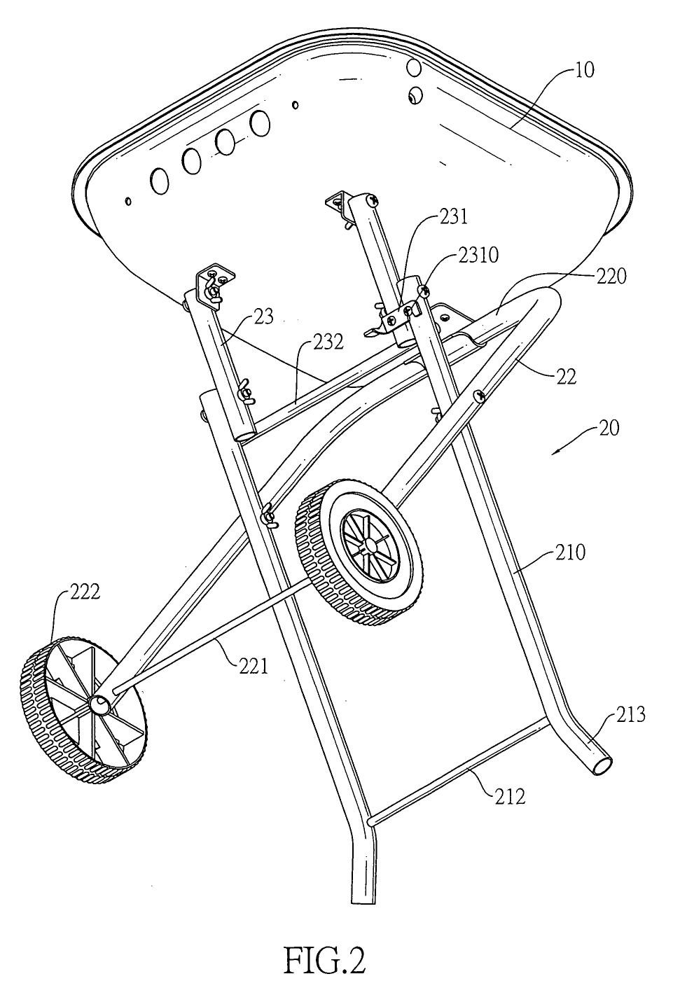

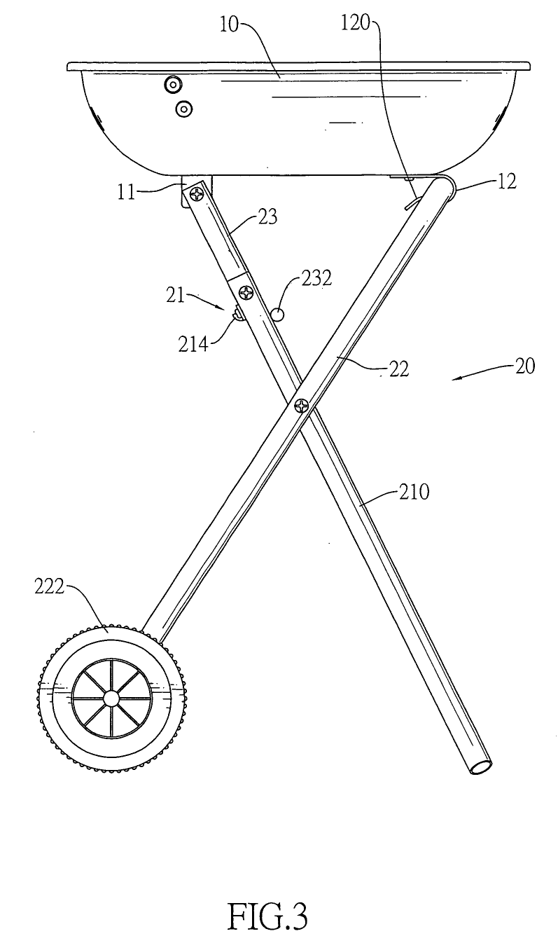

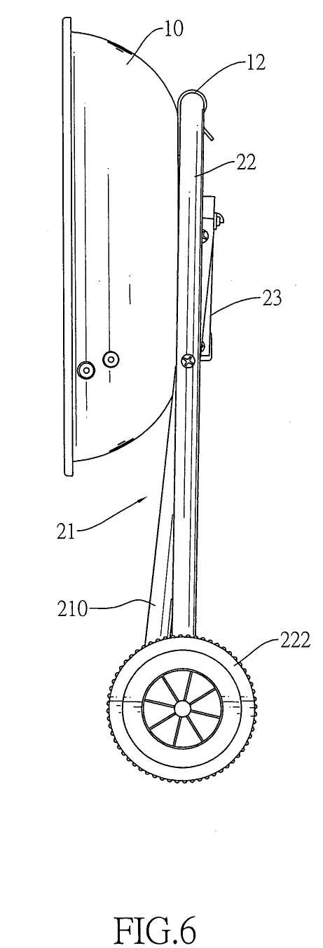

With reference to FIGS. 1, 2, 3 and 6, a portable barbeque in accordance with present invention comprises a grill (10) and a stand (20).

The grill (10) has a front end, a rear end, a bottom, two mounting brackets (11) and a retainer (12). The mounting brackets (11) are oppositely mounted in the bottom near the front end of the grill (10). The retainer (12) is mounted in the bottom near the rear end of the grill (10), may be a resilient metal hook having a lip (120).

The stand (20) is mounted in the bottom of the grill (10) and comprises a primary leg assembly, a secondary leg (22) and two optional support struts (212)(221).

The primary leg assembly is mounted on the mounting brackets (11) and comprises two primary legs (21), a latch and a limiting strut (232). Each primary leg (21) includes a pivot pole (23) and a main pole (210).

Each pivot pole (23) has an upper end and a lower end. The upper end of the pivot pole (23) is pivotally connected to one of the mounting brackets (11) in the bottom of the grill (10).

Each main pole (210) is pivotally mounted adjacent to the lower end of a corresponding pivot pole (23), selectively positioned parallel with the pivot pole (23) and has an upper end and a lower end (213). The upper end of each mail pole is pivotally connected adjacent to the lower end of the corresponding pivot pole (23) to ensure the lower end of the pivot pole (23) protrudes past a pivotal connection. The lower end (213) of each main pole (210) abuts the ground, and may be outwardly curved for increased stability.

The latch is mounted on the pivot pole (23) and selectively locking a corresponding main pole (210), may be parallel to a corresponding main pole (210) and may include any present known devices or structures providing a locking function, such as but not limited to: a sliding bolt cooperating with a corresponding hole, the bolt may further comprise a resilient device; a strap; a rotable hinge with detent, a catch (231) and bar (214) or the like.

Preferably, the latch is implemented as a catch (231) and a bar (214). The at least one catch (231) is transversally mounted rotatably on a front surface of the lower end of a corresponding pivot pole (23) and has a notch (2310) and a handle formed respectively in two ends of the catch (231). The at least one bar (214) is attached to and protrudes from a front surface of a corresponding main pole (210), corresponds to and is selectively mounted in the catch (231) to selectively prevent the primary leg assembly bending forwards. The at least one bar (214) may be a fastener. The at least one bar (214) may be formed on and protrude from the upper end of the corresponding main pole (210).

The limiting strut (232) is mounted between and across the lower ends of the two pivot poles (23) and has two ends protruding out from the pivot pole (23) corresponding to the main poles (210) to limit rotation of the primary leg assembly when being bent backwards.

The secondary leg (22) may be “U” shaped and has a crossbar (220), two leg poles and multiple wheels (222). The crossbar (220) is selectively mounted detachably in the retainer (12) and may be retained by the lip (120). The leg poles are attached to and protrude substantially perpendicularly from the crossbar (220) and are pivotally connected to the main poles (210) of the primary legs (21) near the upper ends of the main poles (210). The wheels (222) are rotatably mounted respectively on the lower ends of the secondary leg (22).

The support struts (212, 221) are respectively mounted securely between the lower ends (213) of the main poles (210) of the primary legs (21) and the leg poles of the secondary leg (22). With such an arrangement, the structure of the stand (20) can be effectively strengthened.

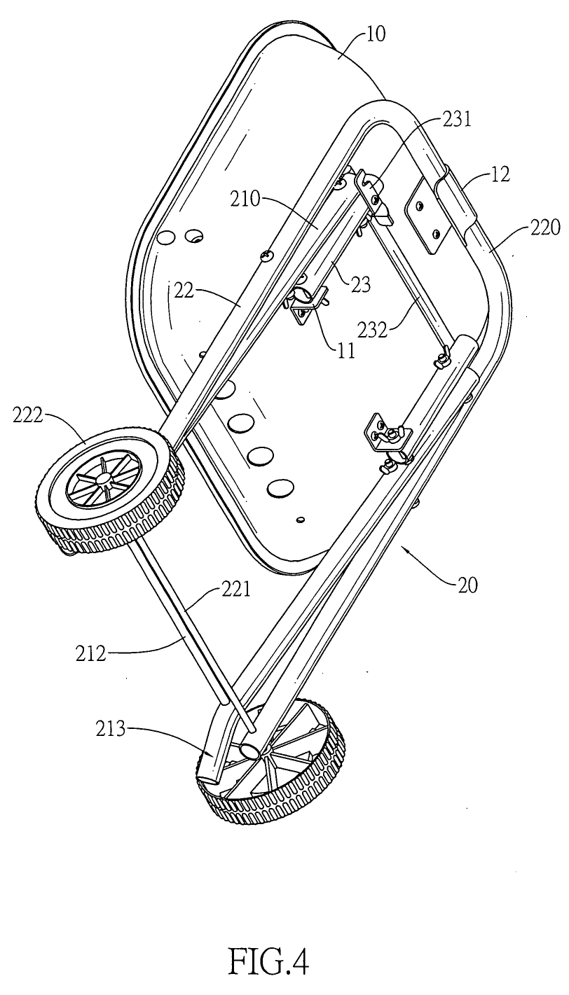

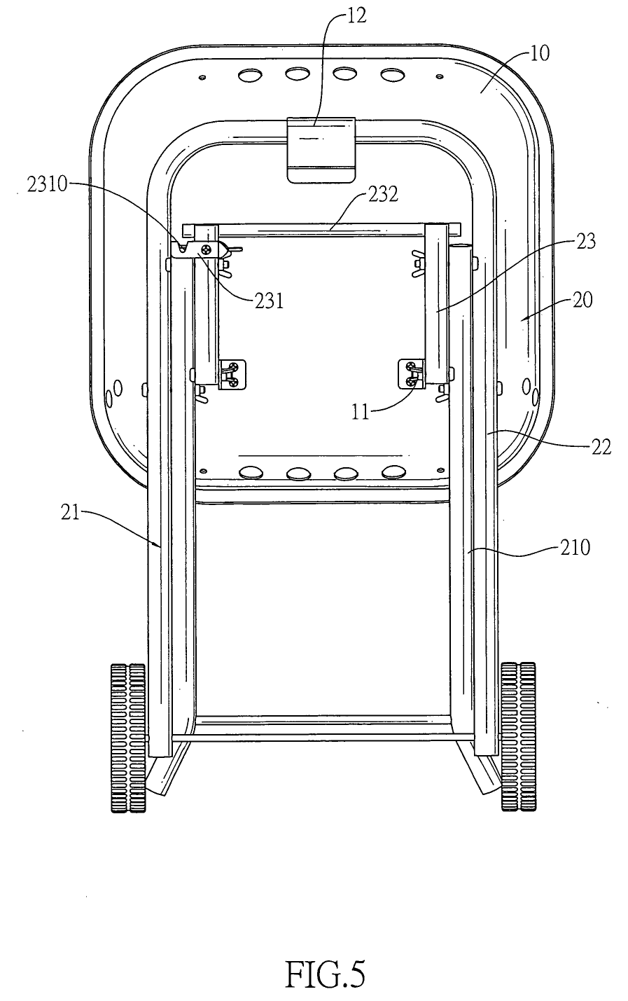

With further reference to FIGS. 4, 5 and 6, when folding the stand (20), the catch (231) is unhooked from the protrusion (214). Then the main pole (210) and primary leg assembly are pivoted and the latter is bent away from the front end of the grill (10) to lean against each other. Since the pivot pole (23) rotates backward and the main pole's (210) forward, the main pole (210) can be selectively configured to be a same length or shorter than the leg poles of the secondary leg (22). Therefore, the folded foldable barbeque has a smaller footprint for convenient storage. Furthermore, when transporting the foldable barbeque, the wheels (222) allow convenient transportation.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. A portable barbeque comprising
a grill having
a front end;
a rear end;
a bottom;
two mounting brackets being oppositely mounted in the bottom near the front end of the grill; and
a retainer being mounted in the bottom near the rear end of the grill; and
a stand being mounted in the bottom of the grill and comprising
a primary leg assembly being mounted on the mounting brackets and comprising
two primary legs, each including
a pivot pole having
an upper end being pivotally connected to one of the mounting brackets in the bottom of the grill; and
a lower end; and
a main pole being pivotally mounted adjacent to the lower end of the pivot pole, selectively positioned parallel with the pivot pole and having
an upper end being pivotally connected adjacent to the lower end of the pivot pole; and
a lower end; and
a latch mounted on one of the pivot poles and selectively locking a corresponding main pole; and
a secondary leg having
a crossbar being selectively mounted detachably in the retainer;
two leg poles being attached to and protruding perpendicularly from the crossbar and being pivotally connected to the main poles of the primary legs near the upper ends of the main poles; and
multiple wheels being rotatably mounted respectively on lower ends of the secondary leg.

2. The portable barbeque as claimed in claim 1, wherein the latch comprising
a catch being transversally mounted rotatably on a front surface of the lower end of the corresponding pivot pole and having a notch and a handle, the notch and handle being formed respectively in two ends of the catch; and
a bar being attached to and protruding from a front surface of the upper end of the corresponding main pole, corresponding to and being selectively mounted in the catch.

3. The portable barbeque as claimed in claim 2, wherein the stand further has a limiting strut being mounted between and across the lower ends of the two pivot poles and having two ends protruding out from the pivot poles and corresponding to the main poles to limit rotation of the primary leg assembly.

4. The portable barbeque as claimed in claim 3, wherein
the retainer of the grill is a resilient metal hook having a lip; and
the crossbar of the secondary leg is selectively retained by the lip of the retainer.

5. The portable barbeque as claimed in claim 3, wherein the secondary leg is “U” shaped.

6. The portable barbeque as claimed in claim 3, wherein the lower end of each main pole is outwardly curved.

7. The portable barbeque as claimed in claim 3 further having two support struts being respectively mounted securely between the lower ends of the main poles of the primary legs and the leg poles of the secondary leg.
